(19) United States
(12) Patent Application Publication
(10) Pub. No.: US 2016/0035310 A1
(43) Pub. Date: Feb. 4, 2016

(54) DISPLAY DEVICE AND ITS WORKING METHOD

(71) Applicant: BOE TECHNOLOGY GROUP CO., LTD., Beijing (CN)

(72) Inventors: Song Song, Beijing (CN); Shiming Shi, Beijing (CN)

(21) Appl. No.: 14/525,146

(22) Filed: Oct. 27, 2014

(30) Foreign Application Priority Data
Jul. 29, 2014 (CN) 201410365016.2

(51) Int. Cl. G09G 5/00; G06F 3/03; G06F 3/01

(52) U.S. Cl. CPC G09G 5/003; G06F 3/017; G06F 3/0304; G09G 2380/02

(57) ABSTRACT

The disclosure discloses a display device comprising a display unit; a support unit for supporting the display unit; a plurality of sensors, each of which is used for sensing a signal emitted by a signal source to identify the distance between the signal source and the sensor; a positioning unit for determining the position of the signal source according to a plurality of identified distances; and a control unit for adjusting the form and/or azimuth of the display unit according to the determined position of the signal source. The display device of the disclosure can automatically regulates the form and/or azimuth of the display screen according to the position of a viewer or a signal source such as an infrared remote controller, thereby realizing a best viewing angle and a best viewing effect for the user.

### RELATED APPLICATIONS

The present application claims the benefit of Chinese Patent Application No. 201410365016.2, filed Jul. 29, 2014, the entire disclosure of which is incorporated herein by reference.

### FIELD OF THE INVENTION

The disclosure relates to the field of display technologies, and in particular, to a display device of which the form and azimuth may be automatically adjusted and its working method.

### BACKGROUND OF THE INVENTION

Nowadays, a display device as an important interface for human-computer interaction has been widely applied in daily life. With the rapid development of display technologies, display devices such as a TV set prevail increasingly, and new products emerge endlessly. However, the existing domestic and commercial display devices are mostly flat display devices, for example, display screens used by liquid crystal televisions, tablet computers, notebook computers, etc. In comparison to previous display devices, although the current flat display devices are significantly improved in terms of definition and portability, etc., there are some insurmountable inherent defects in the flat display devices themselves. A flat display device is often composed of a planar and inflexible display panel (e.g., liquid crystal panel), hence the form of the display screen cannot be regulated to be adapted to a different position of a viewer, and thereby it cannot meet the growing demand for a better and more comfortable viewing effect of consumers.

Of course, with the further development of display technologies, some curved surface display devices also appear. However, for most of the existing curved surface display devices, the azimuth and form cannot be regulated, or the form and azimuth of their display screens can only be regulated simply, but cannot be automatically and adaptively regulated according to the actual viewing position of a viewer so as to achieve a best viewing effect, and therefore it is also difficult to meet the demand for intelligentization of a display device of consumers.

### SUMMARY OF THE INVENTION

An object of the disclosure is to provide a display device for overcoming the above-mentioned drawbacks.

The basic idea of the disclosure is to construct a new display device which utilizes a plurality of sensors to sense a signal sent by a signal source (e.g., an infrared signal source emitting an infrared signal) to determine the position of the signal source and thereby judge the position where a viewer is located; subsequently, the display device automatically regulates the outline or form (e.g., curvature) and azimuth (e.g., direction, height, angle and distance) of the screen according to the position of the viewer, to realize a best viewing angle and a best viewing effect for the user. In addition, the display device may further make use of the above-described principle to identify gesture actions of the user and realize functions corresponding thereto, for example, channel switching, volume tuning or brightness adjustment, etc., and even may utilize the identified gesture actions to realize an individualized adjustment of the form and azimuth of the display screen including the curvature, height, distance, direction, etc.

According to an aspect of the disclosure, there is provided a display device comprising a display unit; a support unit for supporting the display unit; a plurality of sensors, each of which is used for sensing a signal emitted by a signal source to identify the distance between the signal source and the sensor; a positioning unit for determining the position of the signal source according to a plurality of identified distances; and a control unit for adjusting the form and/or azimuth of the display unit according to the determined position of the signal source. Therein, the method in which the positioning unit determines the position of the signal source may be carried out based on the distance formula in space analytic geometry in mathematics.

In an embodiment of the display device according to the disclosure, the sensor may be an infrared sensor, and correspondingly, the signal source may be an infrared signal source, for example, a common infrared remote controller or glasses with an infrared signal emission function, etc. Of course, since the display device of the disclosure may also realize remote control and positioning of the viewer by means of other wireless connection ways than an infrared signal, for example, wireless radio frequency (e.g., bluetooth), ultrasound wave, etc., the sensor and the signal source may also adopt other form corresponding to a connection way.

In an embodiment of the display device according to the disclosure, the display unit may comprise a flexible display panel and a fixing panel disposed behind the flexible display panel, the flexible display panel is connected with the fixing panel through a panel deformation member, and the control unit may control the panel deformation member according to the determined position of the signal source, to adjust the form of the flexible display panel.

In an embodiment of the display device according to the disclosure, the panel deformation member may be a retractable bracket or other member which may cause the flexible display panel to deform, for example, a thermal expansion member, etc., and adjusting the form of the flexible display panel comprises, for example, adjusting its curvature through the panel deformation member, of which the particular process is accomplished by the control unit. For instance, the control unit may adjust the degrees of bending of individual parts of the flexible display panel by controlling the extension or retraction of the retractable bracket, and thereby adjust the form of the flexible display panel to be adapted to the azimuth of the viewer.

In an embodiment of the display device according to the disclosure, the support unit may comprise a base and a support member disposed on the base and connected with the display unit, wherein the base is rotatable and the support member is retractable, and the control unit is further used for controlling the base to rotate and the support member to extend or retract according to the determined position of the signal source, to adjust the direction and/or height of the flexible display panel. As such, the control unit may adapt the curvature, height and direction of the flexible display panel simultaneously according to the position of the signal source (or according to the position of a viewer holding the signal source), thereby achieving a better visual effect.

In an embodiment of the display device according to the disclosure, the support member may be connected with the display unit via a horizontally axially rotatable mechanism, and the control unit is further used for controlling the horizontally axially rotatable mechanism according to the determined position of the signal source, thereby adjusting the angle of elevation or depression of the flexible display panel relative to the horizontal plane. In addition, the support member may be connected with the base via a slidable mechanism, and the control unit may be further used for controlling the slidable mechanism according to the determined position of the signal source so as to cause the support member to translate forward and backward relative to the base, thereby adjusting the distance between the flexible display panel and the determined position of the signal source. By adjustment of the angle of elevation or depression of the flexible display panel and the distance to the signal source in conjunction with other parameters described above (e.g., curvature, height and direction), it may be easier to achieve a best viewing effect.

In an embodiment of the display device according to the disclosure, the driving modes for the above-described retractable bracket, the support member and the base, as well as the horizontally axially rotatable mechanism and the slidable mechanism may comprise an electrical, hydraulic, pneumatic or electromagnetic mode, etc.

In an embodiment of the display device according to the disclosure, the sensors may be disposed in the periphery of the flexible display panel or disposed anywhere on the display device where the signal emitted by the signal source may be sensed. The positioning unit and the control unit may be disposed in the fixing panel or the flexible display panel. Typically, they may be disposed in the fixing panel, because they may relate to a driving apparatus or circuit for controlling individual components and thus are not suitable for being placed in the deformable flexible display panel.

According to another aspect of the disclosure, there is provided a working method of a display device, wherein the display device comprises a display unit, a control unit, a plurality of sensors, a positioning unit and a signal source matching with these sensors, the method comprises the steps of: the plurality of sensors sensing a signal emitted by the signal source and hereby identifying the distance between the signal source and each sensor; the positioning unit determining the position of the signal source according to a plurality of identified distances; and the control unit adjusting the form and/or azimuth of the display unit according to the determined position of the signal source.

In an embodiment of the working method of the display device according to the disclosure, where the display unit comprises a flexible display panel and a fixing panel disposed behind the flexible display panel and the flexible display panel and the fixing panel are connected via a panel deformation member, the step of adjusting the form and/or azimuth of the display unit may comprise controlling the panel deformation member to adjust the form of the flexible display panel.

According to yet another aspect of the disclosure, there is provided a working method of a display device, wherein the display device comprises a display unit, a control unit, a plurality of sensors, a positioning unit and a signal source matching with these sensors, the signal emitted by the signal source comprises two kinds of different signals, namely, a first signal and a second signal, the working method comprises the following steps of:

the sensors of the display device sensing the signal emitted by the signal source;

when the sensed signal is the first signal, performing the steps of: identifying the distance between the signal source and each sensor; the positioning unit determining the position of the signal source according to a plurality of identified distances; and the control unit adjusting the form and/or azimuth of the display unit according to the determined position of the signal source; and

when the sensed signal is the second signal, performing the steps of: at multiple moments spaced by a predetermined length of time within a predetermined time interval, the sensors and the positioning unit repeatedly performing the above steps of identification and positioning, thereby determining the positions of the signal source at the multiple moments; the positioning unit performing curve fitting based on the position points of the signal source at the multiple moments, thereby obtaining the motion trajectory of the signal source within the predetermined time interval; and the control unit controlling the display unit to generate a feedback according to the obtained motion trajectory. In fact, the first and second signals may correspond to an “adjustment function” (i.e., azimuth and/or form adjustment function) and a “gesture function” (i.e., gesture identification function), respectively.

In this manner, not only an automatic adjustment of the form and/or azimuth of the display unit may be accomplished, but also an action tracking of the signal source or remote controller may be realized, namely, a function of tracking the gestures of the viewer, and the display device may make a feedback response according to the gesture actions, namely, the control unit may perform a corresponding function, for example, comprising channel switching, brightness adjustment or sound adjustment, etc. Hence, the display device may implement a function similar to the input device “mouse” used by a computer. In addition, the feedback response or the corresponding function may further comprise that the control unit controls the display unit to change the form and azimuth according to a gesture action, for example, controls the panel deformation member to cause the flexible display panel to deform. In particular, the viewer performs a further regulation for various parameters of the form and azimuth of the flexible display panel, e.g., height, angle, direction, distance, curvature, etc., according to a gesture action, so as to realize a personalized adjustment on the basis of the automatic adjustment (which may serve as a beneficial and necessary supplement to the automatic adjustment), thereby meeting the personalized demand of a different person.

### BRIEF DESCRIPTION OF THE DRAWINGS

Various aspects, features and advantages of the disclosure will be easy to understand according to the following detailed description and the drawings in which

FIGS. 1A and 1B show schematically a front view and a side view of a display device according to an embodiment of the disclosure, respectively;

FIGS. 2A and 2B show schematically a top view of a base and a side view of the structure of a support member, respectively;

FIGS. 3A and 3B show schematically a front view of a flexible display panel of a display unit of a display device according to an embodiment of the disclosure and a front view of a fixing panel behind it, respectively;

FIG. 4 shows schematically a side view of a display unit of a display device according to an embodiment of the disclosure and an enlarged drawing of a part thereof;

FIG. 5 shows schematically a diagram of the working principle in which a display device according to an embodiment of the disclosure utilizes a plurality of sensors to position a signal source;

FIG. 6 shows a schematic block diagram of a display device according to an embodiment of the disclosure, wherein the arrows indicate the direction of a signal flow;

FIGS. 7A and 7B show schematically side views of the deformation effect of a flexible display panel regulated with respect to different positions of a signal source according to an embodiment of the disclosure, respectively;

FIG. 8 shows schematically a flow chart of a working method of a display device according to an embodiment of the disclosure; and

FIG. 9 shows schematically a “gesture” trajectory obtained by tracking by a display device according to an embodiment of the disclosure in a “gesture function” state.

It is to be noted that these drawings are only schematic and illustrative, and not necessarily drawn to scale. Individual elements in the figures are denoted with three digits, the first digit usually represents a figure number, and the remaining two digits designate the element, and therefore the last two digits of the same element in different drawings are identical.

### DETAILED DESCRIPTION OF THE INVENTION

In the following the disclosure will be described in more detail and completely with reference to the drawings.

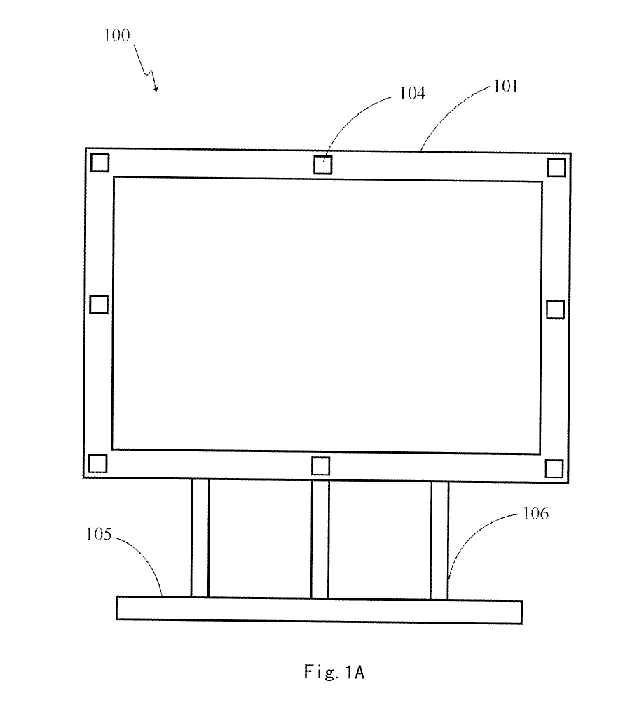

FIGS. 1A and 1B show schematically a front view and a side view of a display device 100 according to an embodiment of the disclosure, respectively. The display device 100 comprises a display unit, a support unit, a plurality of sensors 104 and a control unit (not shown in the figure), wherein the control unit is communicatively connected with the sensors 104, the display unit and the support unit, and the control unit is used for controlling the display unit to change its form and/or azimuth. As shown in FIG. 1B, the display unit may comprise a flexible display panel 101, a fixing panel 102 disposed behind the flexible display panel 101, and a panel deformation member 103 such as a retractable bracket for connecting them, and the control unit may control the panel deformation member 103 to cause the flexible display panel 101 to deform. As shown in FIG. 1A, the support unit may comprise a base 105 and a support member 106 disposed on the base, and the plurality of sensors 104 may be disposed in the periphery of the flexible display panel 101. Furthermore, the control unit may be disposed on the fixing panel 102.

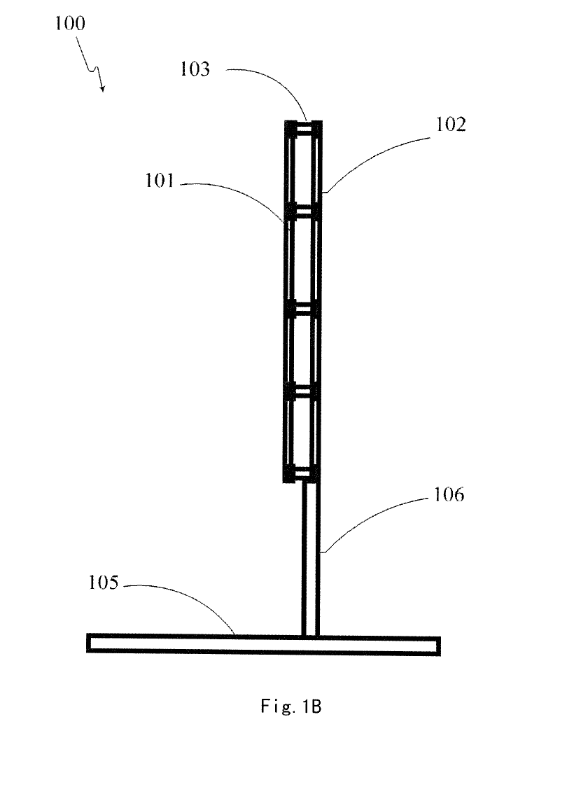

FIGS. 2A and 2B show schematically a top view of the base 205 and a side view of the structure of the support member 206, respectively. Further, the base 205 as shown in FIG. 2A is rotatable, for example, may rotate 90 degrees or 180 degrees or 360 degrees clockwise and counterclockwise, thereby automatically changing the overall direction of the display unit. As shown in FIG. 2B, the support member 206 may be retractable, in its structure there may be comprised a retractable mechanism 207 such as a spring, which may be extended or retracted as needed for example by an electrical, hydraulic, pneumatic or electromagnetic mode, etc., thereby achieving an automatic height regulation of the display unit.

In addition, the support member 206 may be connected with the display unit via a horizontally axially rotatable mechanism (not shown), and thereby the angle of elevation or depression of the flexible display panel 101 as shown in FIGS. 1A and 1B relative to the horizontal plane may be adjusted as needed. Moreover, also the support member 206 may be connected with the base 205 via a slidable mechanism, so as to realize to some extent a forward and backward translation of the support member 206 along with the display unit relative to the base 205, thereby adjusting the distance between the flexible display panel 101 and the determined position of a signal source as desired.

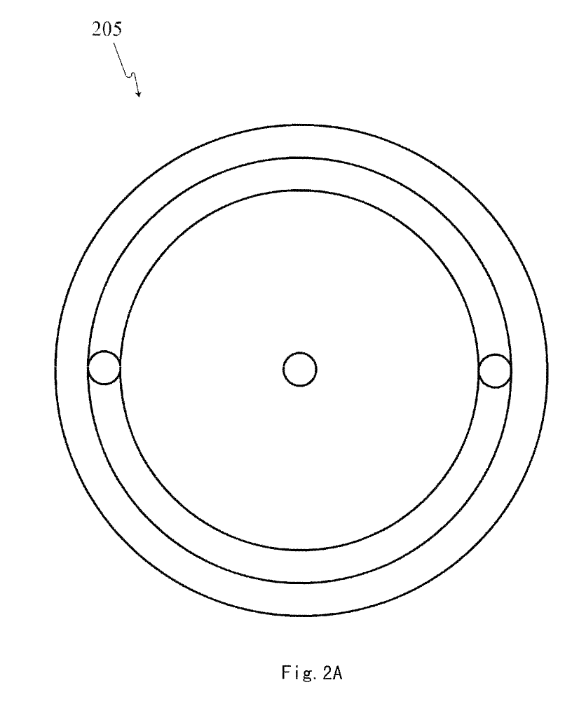

FIGS. 3A and 3B show schematically a front view of the flexible display panel 301 and a front view of the fixing panel 302, respectively. As shown in FIG. 3A, a plurality of sensors 304 are arranged in the periphery of the flexible display panel 301 for sensing a signal emitted by a signal source (not shown) and identifying the distance between the signal source and each sensor 304. As shown in FIG. 3B, a plurality of panel deformation members 303, for example, retractable brackets 303, are disposed on the fixing panel 302, and each retractable brackets 303 may be controlled by the control unit to extend or retract in a driving mode such as an electrical, hydraulic, pneumatic or electromagnetic mode, etc., thereby adjusting the form of the flexible display panel 301, such as the curvature.

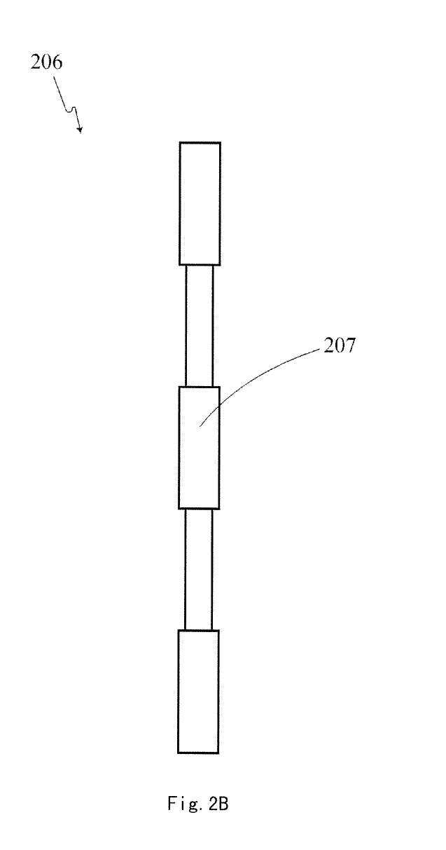

FIG. 4 shows schematically a side view (left) of a display unit of a display device according to an embodiment of the disclosure and an enlarged drawing (right) of a part thereof. As shown in FIG. 4, the flexible display panel 401 is connected with the fixing panel 402 via a panel deformation member 403. The flexible display panel 401 may be an existing flexible display screen in the art of which the curvature may be regulated, whereas the fixing panel 402 does not have a display function and is just an ordinary panel playing an auxiliary function, which is mainly used for fixing the panel deformation member 403 and for arranging the control unit (not shown) and the positioning unit (not shown), and may be further used for being connected with the support unit (not shown). The panel deformation member 403 may be a retractable bracket 403, which for example has a retractable mechanism such as a spring for changing the shape of the flexible display panel 401. In addition, corresponding driving circuits or driving apparatuses of other types (which depends on the driving mode, for example, the electrical, hydraulic, pneumatic or electromagnetic mode, etc. as described above) for driving the panel deformation member 403, the support member, the base, etc. may be disposed in the fixing panel 402 and controlled by the control unit, thereby realizing the regulation of the form and azimuth of the flexible display panel 401 as described above. For clarity and simplicity of the expression, in the following these driving apparatuses or driving circuits will be omitted, and it is directly expressed that these components of the display device are controlled and driven by the control unit.

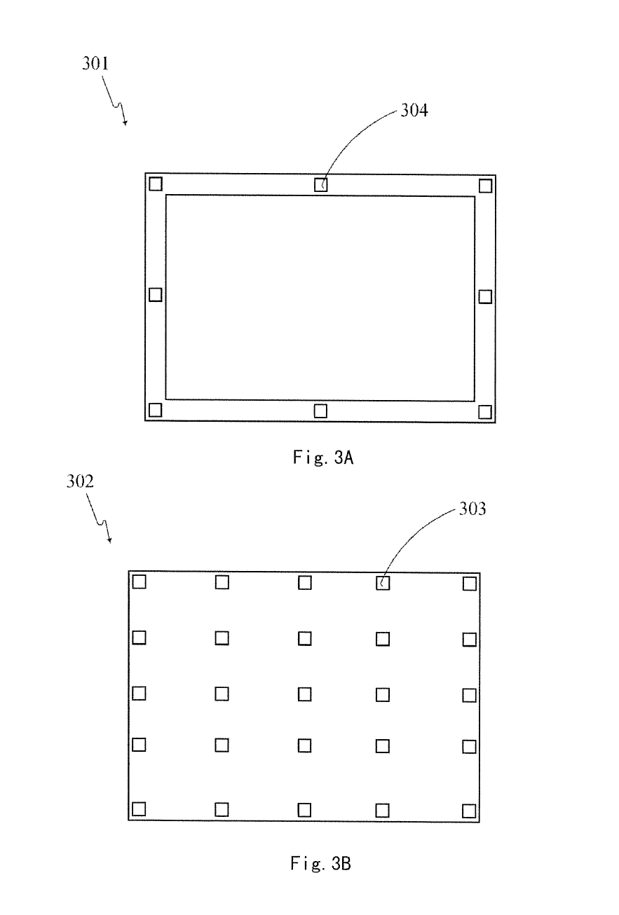

FIG. 5 shows schematically the principle in which a plurality of sensors 504 of a display device according to an embodiment of the disclosure locate a signal source 508. The sensor 504 may be a common infrared sensor 504, and correspondingly, the signal source 508 may be an infrared signal source 508, for example, an infrared remote controller or glasses with an infrared signal emission function, etc. In the following, taking the infrared signal source 508 and the infrared sensor 504 as an example, the principle of positioning the signal source 508 will be described, which is equally suitable for other types of signal sources and corresponding sensors. When the display device is in a normal operation, a viewer triggers the infrared signal source 508 such as an infrared remote controller or glasses with an infrared signal emission function to emit an infrared signal. As shown in the figure, the plurality of sensors 504 sense the infrared signal respectively and compute the distance from the infrared signal source 508 to each infrared sensor 504 and transmit it to a positioning unit, subsequently, the positioning unit determines the position of the infrared signal source 508 and the distance from the display screen 501 according to these distances, of which the principle is realized by the distance formula in the space geometry. The particular steps are as follows. First, the origin and the three coordinate axes of a space rectangular coordinate system are established, as shown in the figure, it may be assumed that the center point of the display screen 501 is the origin, the x-axis and y-axis are located in the display screen 501 and are horizontal and vertical, respectively, and the z-axis is perpendicular to the display screen 501 and outward. As shown in the figure, let the coordinate of the position point of the infrared signal source 508 be (x, y, z), suppose that the coordinates of three infrared sensors 504 with positions not on one and the same straight line are known to be (x1, y1, 0), (x2, y2, 0) and (x3, y3, 0), respectively, and the distances between them and the infrared signal source 508 are d1, d2 and d3, respectively, then a set of ternary quadratic equations are obtained according to the distance formula in the space geometry:

$$\{ \begin{matrix}{( x - x 1 )}^{2} + {( y - y 1 )}^{2} + {z}^{2} = d {1}^{2} \\ {( x - x 2 )}^{2} + {( y - y 2 )}^{2} + {z}^{2} = d {2}^{2} \\ {( x - x 3 )}^{2} + {( y - y 3 )}^{2} + {z}^{2} = d {3}^{2}\end{matrix}$$

A unique solution must be obtained by solving the set of equations (since z>0), which is the coordinate of the position of the infrared signal source 508, and the distance from the infrared signal source 508 to the display screen 501 is z.

As such, the control unit may determine the azimuth and form of the flexible display panel 501 meeting a best viewing effect according to the computed position of the infrared signal source 508 (thereby judging the position of the eyes of a viewer considering the habit of the viewer using the infrared signal source 508 such as a remote controller) and data of the display device well known in the art, such as a best viewing angle, distance and azimuth, etc., and then accordingly control the above-described individual components (e.g., the retractable bracket, base, support member, etc.) to adjust the individual parameters (e.g., the curvature, height, angle, direction or distance, etc.) as described above of the flexible display panel 501 to be adapted to the azimuth of the viewer.

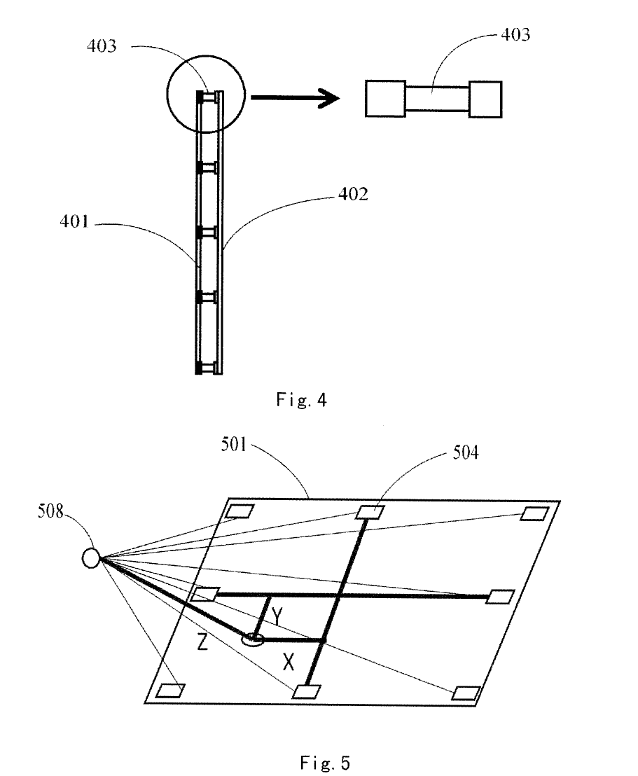

FIG. 6 shows a schematic block diagram of a display device 600 according to an embodiment of the disclosure, wherein the arrows represent the direction of a signal flow during the operation of the display device 600. As shown in FIG. 6, the display device 600 comprises a display unit 609, a support unit 610, a sensor 604, a positioning unit 611 and a control unit 612. Therein, the display unit 609 may comprise a flexible display panel 601, a fixing panel 602 and a panel deformation member 603, and the support unit 610 may comprise a base 605 and a support member 606. As shown in FIG. 6, during the operation of the display device 600, first, a plurality of sensors 604 sense a signal emitted by a signal source (not shown) and accordingly identify the distance from the signal source to the sensor 604, and transmit the plurality of distance data to the positioning unit 611; then, the positioning unit 611 determines the position of the signal source by the method shown with reference to FIG. 5 according to the plurality of identified distance data of the signal source, and transmits the position information to the control unit 612; afterwards, the control unit 612 determines the best viewing form and azimuth of the display unit 609 according to the position information of the signal source and data of the display device 600 such as a television with respect to a viewer, such as a best viewing height, angle, direction, etc. well known in the art, and thus drives components such as the panel deformation member 603, the base 605 and the support member 606, respectively, based on the information and by means of a particular mode such as the electrical, hydraulic, pneumatic or electromagnetic mode, etc., thereby adaptively regulating the parameters of the form and azimuth, such as the curvature, height, distance or direction, of the display unit 609, especially the flexible display panel 601, to let the viewer to achieve a best viewing experience.

In addition, in case of multiple persons viewing the display device 600 such as a television simultaneously, if each person has a remote controller or signal source, the display device may determine corresponding positions of different signal sources respectively by means of the principle as described in FIG. 5 according to different moments in time when sensing a signal emitted respectively by a signal source such as a remote controller of each person, thereby determine a reasonable form and azimuth of the flexible display panel 601 which can optimize the viewing experiences of the multiple persons according to the positions of the individual different signal sources or remote controllers, and accordingly regulate the flexible display panel 601 to achieve an optimized viewing effect taking into account the multiple persons. In case of multiple persons viewing, the particular method for position identification and panel regulation of the flexible display panel 601 is similar to the case of one signal source, and will not be repeated here.

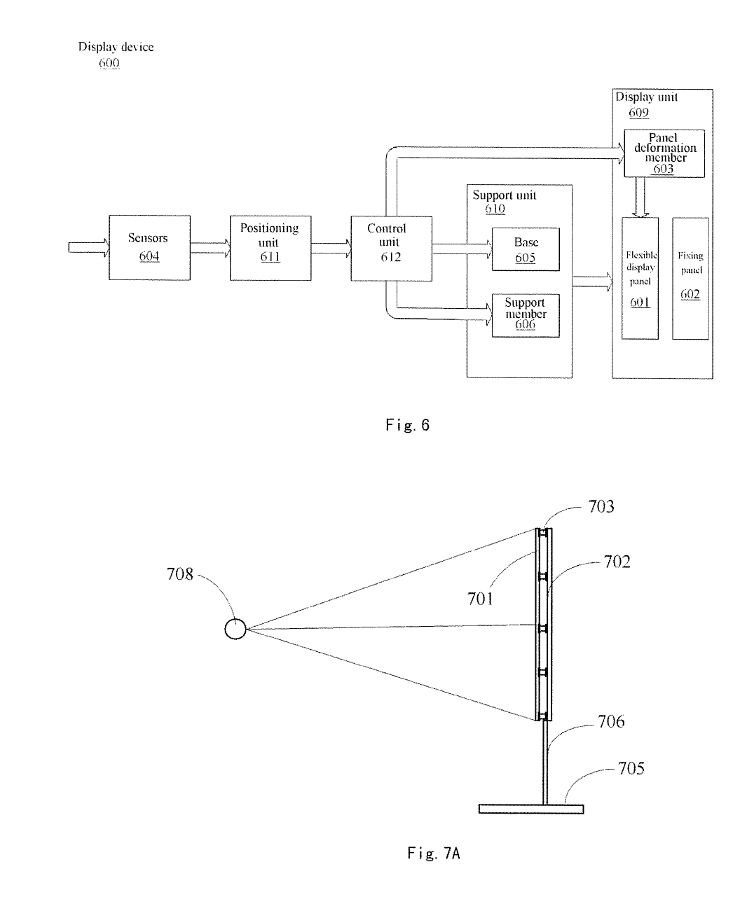

FIGS. 7A and 7B show schematically side views of the bending effect of a flexible display panel 701 regulated with respect to different positions of a signal source 708 according to an embodiment of the disclosure. As shown in FIG. 7A, for the signal source 708, the flexible display panel 701 almost need not be regulated to be able to achieve a best viewing effect. As shown in FIG. 7B, the height of the signal source 708 is comparatively low, and therefore the viewing angle and the viewing effect are not good in the original azimuth and form of the display device as shown in FIG. 7A. As a result, the display device must regulate the azimuth and form of the flexible display panel 701 according to the working principle and process shown in connection with FIG. 5 and FIG. 6. When in regulation, as shown in the side view of FIG. 7B, an upper bracket 703 extends to cause the upper half of the screen to bend forward; a lower bracket 703 retracts to cause the lower screen to bend backward; and the intermediate bracket 703 remains unchanged, namely, the center screen remains unchanged, thereby leading to optimization of the viewing experience of the viewer.

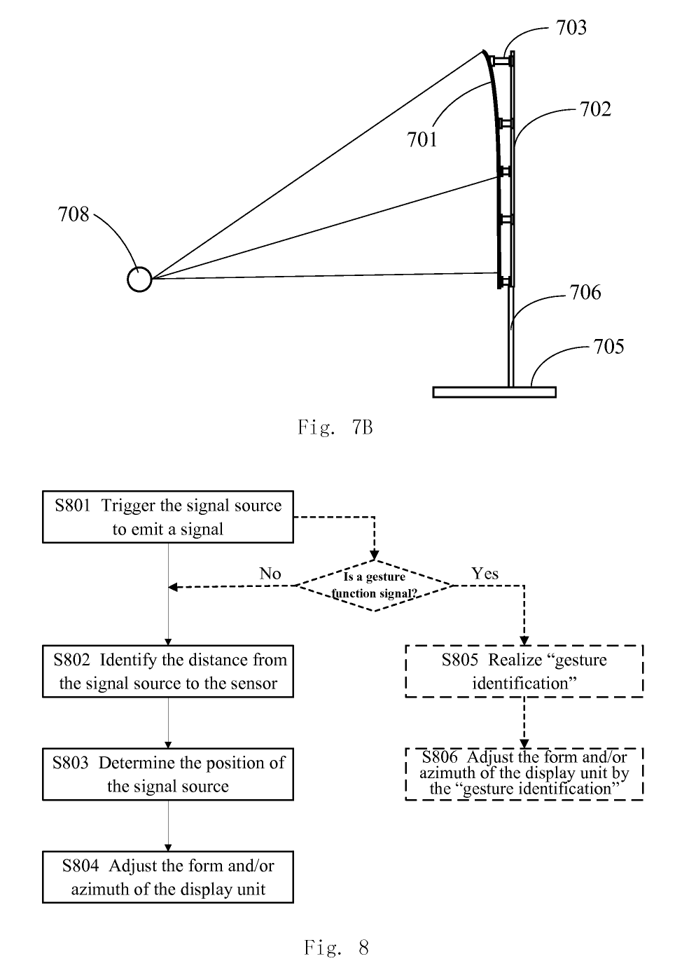

FIG. 8 shows schematically a flow chart of a working method of a display device according to an embodiment of the disclosure. In step S801, a viewer triggers a signal source such as a remote controller or glasses to emit a signal. In step S802, a plurality of sensors of the display device receive the signal to identify the distance from the signal source to each sensor. In step S803, a positioning unit computes the position of the signal source according to the plurality of identified distances, and for the particular positioning method, we can see the principle described in connection with FIG. 5. In step S804, a control unit automatically regulates the form and azimuth of a display unit according to the position of the signal source, for example, by controlling components such as a panel deformation member, a base, a support member, etc. to realize an adaptive regulation of the form and azimuth of a display panel, so as to satisfy a best viewing experience of the viewer, and the particular regulation method is as described with reference to FIG. 6. Further, after the completion of the whole regulation process, the sensors may continue monitoring in real time the emission of a signal, and when the position of the signal source changes, again regulate the form and azimuth of the flexible display panel following the above steps according to the new position.

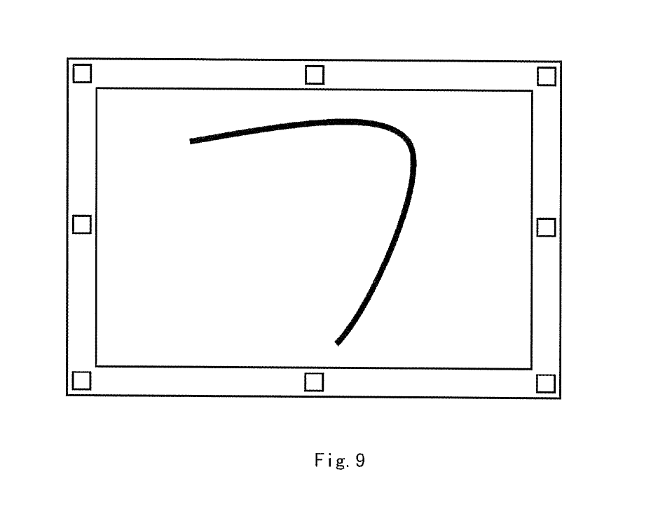

Furthermore, in addition to the above adaptive regulation of the azimuth and/or form of the flexible display panel, the dotted portions in the flow chart of FIG. 8 show optional steps of a working method of a display device according to an embodiment of the disclosure. In response to sensing a “gesture function” specific signal, in an optional step S805, the function of gesture identification (the function of gesture identification will be described with reference to FIG. 9 in detail in the following) which is similar to the “mouse function” may be implemented utilizing a method similar to FIG. 5 in which a signal source such as a remote controller is addressed or located by a plurality of sensors. Furthermore, if a user desires, in a optional step S806, the viewer may further perform a manual regulation on the form and/or azimuth of the display unit on the basis of an automatic regulation according to his own preference and personalized demand, to realize a personalized viewing effect. In particular, for example, the display device may identify a gesture of the user or a moving action of the signal source by the function of gesture identification described in the following with reference to FIG. 9, and then may perform a corresponding regulation according to the identified gesture. As such, the user realizes an adjustment on demand of the form and/or azimuth of the display unit by means of a simple gesture action.

FIG. 9 shows schematically a “gesture” trajectory obtained by tracking by a display device according to an embodiment of the disclosure in a “gesture function” state. With respect to the implementation of the “gesture function”, in particular, two different buttons “adjustment function” and “gesture function” may be set on a signal source or remote controller used cooperatively with the display device in advance, and they emit respectively different signals (i.e., a first signal and a second signal) by triggering, to drive the display device sensing these signals to realize different functions. In general, the “adjustment function” corresponds to steps S801-S804 described in FIG. 8, namely, adjusting the form and/or azimuth of the display unit according to the position of a signal source emitting the first signal; whereas the “gesture function” indicates a moving action of the signal source is tracked and identified according to the second signal (i.e., the “gesture function” specific signal described above), and corresponds to the optional step S805 in FIG. 8. In an actual operation, the viewer may first emit the first signal by triggering the “adjustment function” button, causing the display device to enter a “adjustment function” state, namely, the adjustment of the form and/or azimuth of the display unit is implemented by the steps of identification, poisoning, adjusting, etc.; afterwards, the state may be switched to a “gesture function” state by triggering the “gesture function” button, namely, the plurality of sensors and the positioning unit may track a moving action of the remote controller by sensing the second signal emitted by it, and display the moving trajectory on the screen, as shown in FIG. 9.

The principle of gesture action tracking is similar to the method for positioning a signal source in the above embodiment, and the difference lies in that tracking a gesture action during the movement of the signal source needs to position the signal source continuously, and subsequently perform a curve fitting of the position points at multiple moments obtained by continuous positioning in order to get the moving trajectory of the signal source. The particular implementation process of the “gesture function” (i.e., step S805 in FIG. 8) is as follows: when the sensors of the display device sense the second signal (e.g., an infrared pulse signal) corresponding to the “gesture function” button of the signal or remote controller, first a time spacing is determined according to the approximate completion time of the gesture action, for example, ⅓, ⅕ or 1/10 seconds, etc., as well as the number of position points needing to be positioned (e.g., 20 or more, wherein the more the number of the points, the less the error, and the more the curve obtained by fitting approximates the real trajectory, however, an excessively large number may affect the computation time), thereby determining the positioning moments, and subsequently the sensors and the positioning unit repeatedly perform the steps of identification and positioning at individual moments following the above described method, thereby determining the position points of the remote controller at multiple moments; next, the positioning unit performs a curve fitting based on the position points of the remote controller at the multiple moments, thereby obtaining the curve of the motion trajectory of the remote controller within the predetermined time interval, wherein the algorithm of curve fitting may adopt the least square method, the Lagrange interpolation method, the Newton interpolation method, the Newton iteration method, etc. Furthermore, the control unit may further control the display unit to generate a feedback according to the obtained motion trajectory, i.e., the control unit in the display device may further implement respective different functions according to identified different gesture actions, for example, like in a touch screen, an “up and down” movement corresponds to increasing and decreasing the volume respectively, a “left and right” movement corresponds to, for example, the channel switching of a television or the switching of a movie played in a tablet computer.

Of course, as shown in step S806 in FIG. 8, also the manual regulation of the azimuth and/or form of the display unit described above utilizing the “gesture function”, namely, the regulation of the azimuth and/or form of the display unit, especially the flexible display panel may be realized according to a gesture action of the viewer, thereby realizing a personalized adjustment of the display effect and the viewing effect of the display device.

It is to be noted that in claims, the use of the verb “comprise” and its conjugation does not preclude the existence of an element or step not stated in a claim. The word “a” or “an” does not preclude a plurality.

While particular embodiments of the disclosure have been illustrated and described, for those skilled in the art, various changes and modifications may be made in broader aspects thereof without departing the disclosure. Therefore, the claims should encompass all such changes and modifications within their scope, as if they fall within the true spirit and scope of the disclosure.

1. A display device comprising
a display unit;
a support unit for supporting the display unit;
a plurality of sensors, each of which is used for sensing a signal emitted by a signal source to identify the distance between the signal source and the sensor;
a positioning unit for determining the position of the signal source according to a plurality of identified distances; and
a control unit for adjusting the form and/or azimuth of the display unit according to the determined position of the signal source.

2. The display device as claimed in claim 1, wherein the display unit comprises a flexible display panel and a fixing panel disposed behind the flexible display panel, the flexible display panel is connected with the fixing panel through a panel deformation member, and the adjusting the form and/or azimuth of the display unit comprises controlling the panel deformation member to adjust the form of the flexible display panel.

3. The display device as claimed in claim 2, wherein the support unit comprises a base and a support member disposed on the base and connected with the display unit, wherein the base is rotatable and the support member is retractable, and the adjusting the form and/or azimuth of the display unit comprises controlling the base to rotate and the support member to extend or retract to adjust the direction and/or height of the flexible display panel.

4. The display device as claimed in claim 3, wherein the support member is connected with the display unit via a horizontally axially rotatable mechanism, and the adjusting the form and/or azimuth of the display unit comprises controlling the horizontally axially rotatable mechanism to adjust the angle of elevation or depression of the flexible display panel relative to the horizontal plane.

5. The display device as claimed in claim 3, wherein the support member is connected with the base via a slidable mechanism, and the adjusting the form and/or azimuth of the display unit comprises controlling the slidable mechanism to cause the support member to translate forward and backward relative to the base, thereby adjusting the distance between the flexible display panel and the determined position of the signal source.

6. The display device as claimed in claim 4, wherein the driving modes for the panel deformation member, the support member and the base, and the horizontally axially rotatable mechanism comprise an electrical, hydraulic, pneumatic or electromagnetic mode.

7. The display device as claimed in claim 2, wherein the panel deformation member is a retractable bracket, and the adjusting the form of the flexible display panel comprises adjusting its curvature.

8. The display device as claimed in claim 2, wherein the sensors are disposed in the periphery of the flexible display panel, and the positioning unit and the control unit are disposed in the fixing panel.

9. The display device as claimed in claim 1, wherein the sensors are infrared sensors, and the signal source is an infrared signal source.

10. The display device as claimed in claim 9, wherein the infrared signal source comprises a remote controller or glasses with an infrared signal emission function.

11. A working method of a display device, wherein the display device comprises a display unit, a control unit, a plurality of sensors, a positioning unit and a signal source matching with these sensors, the method comprises the steps of:
the plurality of sensors sensing a signal emitted by the signal source and hereby identifying the distance between the signal source and each sensor;
the positioning unit determining the position of the signal source according to a plurality of identified distances; and
the control unit adjusting the form and/or azimuth of the display unit according to the determined position of the signal source.

12. The method as claimed in claim 11, wherein the display unit comprises a flexible display panel and a fixing panel disposed behind the flexible display panel, the flexible display panel and the fixing panel are connected via a panel deformation member, and the step of adjusting the form and/or azimuth of the display unit may comprise controlling the panel deformation member to adjust the form of the flexible display panel.

13. A working method of a display device, wherein the display device comprises a display unit, a control unit, a plurality of sensors, a positioning unit and a signal source matching with these sensors, wherein the signal emitted by the signal source comprises a first signal and a second signal different from each other, the working method comprises the following steps of:
the sensors of the display device sensing the signal emitted by the signal source;
when the sensed signal is the first signal, performing the steps of:
the sensors identifying the distance between the signal source and each sensor, the positioning unit determining the position of the signal source according to a plurality of identified distances, and the control unit adjusting the form and/or azimuth of the display unit according to the determined position of the signal source; and
when the sensed signal is the second signal, performing the steps of:
at multiple moments spaced by a predetermined length of time within a predetermined time interval, the plurality of sensors and the positioning unit repeatedly performing the steps of identification and positioning, thereby determining the position points of the signal source at the multiple moments; the positioning unit performing curve fitting based on the position points of the signal source at the multiple moments, thereby obtaining the motion trajectory of the signal source within the predetermined time interval; and the control unit controlling the display unit to generate a feedback according to the obtained motion trajectory.

14. The method as claimed in claim 13, wherein the step of controlling the display unit to generate a feedback comprises controlling the display unit to perform channel switching, brightness adjustment or volume adjustment.

15. The method as claimed in claim 13, wherein the step of controlling the display unit to generate a feedback comprises adjusting the form and/or azimuth of the display unit.
